(19) United States
(12) Patent Application Publication
(10) Pub. No.: US 2010/0229232 A1
(43) Pub. Date: Sep. 9, 2010

(54) SUBSCRIPTION AND DEVICE OF CHARGE CONTROL

(75) Inventors: Vesa Pauli Hellgren, Helsinki (FI); Michael Jung, Berlin (DE)

Correspondence Address: STAAS & HALSEY LLP, SUITE 700, 1201 NEW YORK AVENUE, N.W., WASHINGTON, DC, 20005, US

(73) Assignee: NOKIA SIEMENS NETWORKS OY, ESPOO (FI)

(21) Appl. No.: 12/733,796

(22) PCT Filed: Aug. 20, 2008
(86) PCT No.: PCT/EP2008/060874

§ 371 Date: Mar. 19, 2010

(30) Foreign Application Priority Data
Sep. 21, 2007 (EP) 07116918.9

(51) Int. Cl. H04L 9/32; G06F 21/00

(52) U.S. Cl. 726/9

(57) ABSTRACT

A method of providing service authorization by sending a message from a redirect server to a user terminal including an authorization token. The method includes detecting and removing the authorization token by a network gateway node from the message before forwarding the message to the user terminal.

### CROSS REFERENCE TO RELATED APPLICATIONS

This application is the U.S. national stage of International Application No. PCT/EP2008/060874, filed Aug. 20, 2008 and claims the benefit thereof. The International Application claims the benefits of European Application No. 07116918 filed on Sep. 21, 2007, both applications are incorporated by reference herein in their entirety.

### BACKGROUND

The method described below is related to subscription and advice of charge control. In particular, the method relates to performing such a subscription and advice of charge control using network devices having functionalities implemented which configure these network devices to participate in such a method. In addition, the method may be used to pass charging policies from content providers and portals to charging systems without building an explicit interface between those systems.

Recently, efforts to provide subscription and advice of charge control have been undertaken with respect to service provision in (mobile) packet data networks. The network architecture of a typical 3^{rd} generation packet data network (i.e. according to the 3^{rd} generation partnership project—3GPP) is as follows.

There is user equipment (UE) which is the device the (mobile) subscriber uses to access packet data services. The gateway GPRS (general packet radio service) support node (GGSN) is the gateway for user plane traffic. All user plane traffic from an access network traverses via the GGSN before it is forwarded to packet data networks or other user equipment. The GGSN can be replaced with any other packet data gateway element. An online charging system (OCS) provides a real-time credit control for user plane traffic managed in the GGSN. The OCS controls the GGSN over for example diameter credit control application (DCCA) sessions. Eventually, there is a top-up server (TS) which implements interaction with a subscriber if there is need to activate subscriptions or an advice of charge needs to be provided. The top-up server can be replaced with any other redirect server element.

The problem is to provide an end-user dialogue from the top-up server in those cases, where an advice of charge is required or a subscriber needs to activate a subscription, before access to content can be provided. The top-up server could be used also to provide additional service authentication. The top-up server may be needed also in those cases where a prepaid user needs to put more funds on the prepaid account to get access to content.

The problem in these use cases is basically the same. That is, the online charging system detects the need for an end user dialogue towards the top-up server based on events it receives from the gateway GPRS support node. If dialogue is needed, the online charging system should notify the gateway GPRS support node. The gateway GPRS support node should implement a redirection of HTTP (hypertext transfer protocol) or WAP (wireless application protocol) traffic to top-up server, which implements end-user interaction. The online charging system defines service authorization, so it needs to get information about a result of the end-user interaction with the top-up server. In addition, the online charging system also controls redirection, so it needs to notify the gateway GPRS support node when redirection is no longer needed.

Specifically, known solutions for providing service authorization are based e.g. on the standardization work of the Liberty Alliance Project.

However, the Liberty approach is that it is designed for single sign-on functionality and it cannot be used to make service reauthorization decisions based on usage of content resources. The Liberty approach provides support only for the cases where authentication of end user is required for service authorization, while in advice of charge and subscription management cases there are also needs to get explicit consent from the end user before service access can be authorized. In summary, the Liberty approach concentrates only on the cases where service authorization is based on the seamless and immutable authentication of the end user, and this is not sufficient in those cases where service authorization depends on other factors such as policies of end users, usage of service content resources or calendar time.

Furthermore, the online charging system can provide credit control function and service authorization function, but within the prior art solutions, there has not yet been defined a proper way of handling interaction with top-up server and gateway GPRS support node.

Document RFC 4006 of the internet engineering task force (IETF) defines graceful service termination where final-unit-indication AVP (attribute value pair) is used to initiate redirection, and then the online charging system removes the redirection need based on explicit reauthorization procedure (RAR message—reauthorization request message), or reauthorization is done once the validity time for final unit action expires.

However, this solution has the following disadvantages.

It requires that the online charging system has an interface to the top-up server. This interface has not yet been standardized. Further, RAR signalling generates a signalling overhead due to the additional messaging needed. The other alternative of sending the credit control request (CCR) once the validity time expires does not change the service authorization status in real time.

### SUMMARY

Therefore, an aspect is to overcome the shortcomings of the prior art.

Specifically, according to a first aspect, there is provided a method of providing service authorization by sending a message from a redirect server to a user terminal including an authorization token; and detecting and removing the authorization token by a network gateway node from the message before forwarding the message to the user terminal.

Modifications of the first aspect include the following.

The method may further include performing an authorization dialogue by the redirect server with the user terminal, wherein the sending of the message from the redirect server to the user terminal is a response message within that dialogue.

The method may further include initiating a service authorization request by the network gateway node towards an online charging system after the forwarding of the message and before the user terminal requests any traffic after receiving the message.

The sending of any traffic by the user terminal may be delayed by the redirect server.

The service authorization request may be performed by sending a credit control request message to the online charging system which includes the authorization token and asks for permission of a requested service.

The method may further include initiating a redirection of traffic from a user terminal to a redirect server by informing a network gateway node in advance before traffic is sent by the user terminal.

The initiating may be performed in response to the creation of a packet data protocol context for the user terminal.

The network gateway node may be informed in advance by an online charging system.

The network gateway node may be a gateway GPRS support node.

The redirect server may be a top-up server.

According to a second aspect, there is provided a computer program product embodied on a computer-readable medium, wherein the computer program product is configured to provide instructions to carry out a method according to the first aspect or any of its modifications.

According to a third aspect, there is provided a network gateway device which is configured to detect and remove an authorization token from a message of a redirect server to a user terminal; and forward the message to the user terminal thereafter.

Modifications of the third aspect include the following.

The network gateway device may be further configured to send a service authorization request towards an online charging system after the forwarding of the message and before the user terminal requests any traffic after receiving the message.

The network gateway device may be further configured to send the service authorization request with a credit control request message to the online charging system which includes the authorization token, and ask for permission of a requested service.

The network gateway device may be further configured to redirect traffic from a user terminal to a redirect server, before traffic is requested by the user terminal, in response to information received to initiate this redirection.

The network gateway device may be a gateway GPRS support node.

According to a fourth aspect, there is provided a redirect server device, configured to perform an authorization dialogue with a user terminal; and send a response message to the user terminal including an authorization token.

Modifications of the fourth aspect include the following.

The redirect server may be further configured to delay the sending of any traffic requests by the user terminal after the sending of the response message.

The redirect server may be arranged to be a top-up server.

According to a fifth aspect, there is provided an online charging system, configured to process a service authorization request message of a network gateway node including an authorization token.

Modifications of the fifth aspect include the following.

The online charging system may be further configured to grant permission of a requested service.

The online charging system may be configured to process the service authorization request before a service-related user terminal sends any traffic request after receiving a response message from the redirect server.

The online charging system may be configured to process the service authorization request message received as a credit control request message, and to grant permission with a credit control answer message.

The online charging system may be further configured to initiate a redirection of traffic from the user terminal to a redirect server by informing the network gateway node in advance before traffic is sent by the user terminal.

### BRIEF DESCRIPTION OF THE DRAWINGS

These and other aspects and advantages will become more apparent and more readily appreciated from the following description of exemplary embodiments, taken in conjunction with the appended drawings of which:

FIG. 1 is a data sequence diagram of the signalling traffic in a packet data network for providing subscription and advice of charge control according to an embodiment.

### DETAILED DESCRIPTION OF THE PREFERRED EMBODIMENT

In the following, embodiments are described with reference to the accompanying drawing. It should, however, be understood that this description is for illustrative purposes only and that the method is by no means to be construed as being limited to the embodiments described and illustrated.

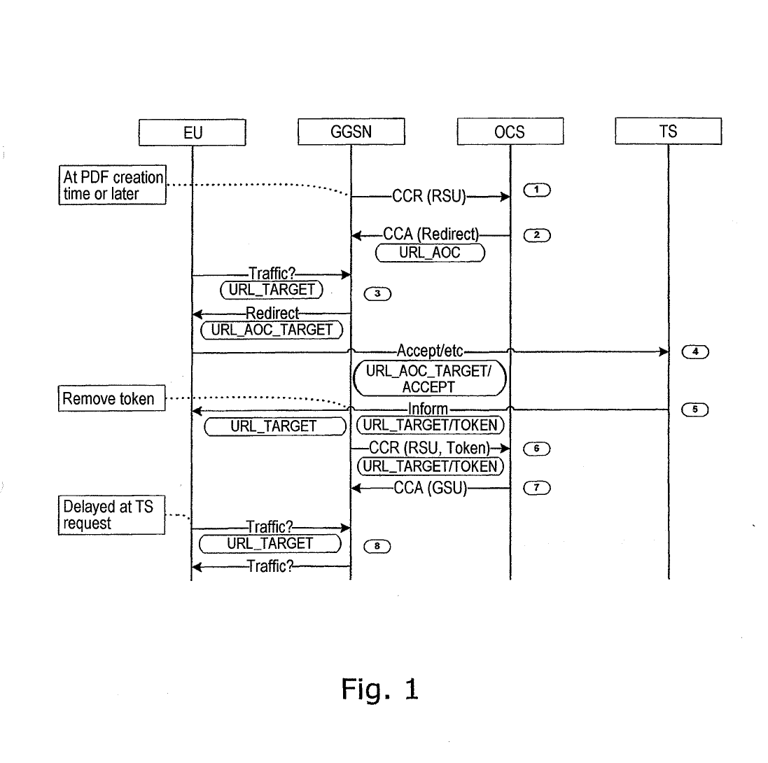

Specifically, FIG. 1 shows embodiments by illustrating signalling between an end user EU (which may participate by e.g. using a user equipment UE), a gateway GPRS support node GGSN, an online charging system OCS, and a top-up server TS. These elements are selected to illustrate an implementation example as a embodiment, but are not intended to limit the method to these specific elements, as mentioned above. For example, the top-up server is illustrated as an implementation of a redirect server, the GPRS support node GGSN as an implementation of a packet data gateway.

Selected processes of the signalling are labelled by reference numerals 1 to 8 which will be referred to in the following as steps 1 to 8. With respect to the depicted elements EU, GGSN, OCS and TS, FIG. 1 is to be construed such that these elements illustrate devices which are to be understood as being configured to perform the illustrated steps.

With respect to certain messages, URL indications are depicted as implementation examples.

Specifically, when a packet data protocol (PDP) context (bearer session) is created, the gateway GPRS support node already sends an initial credit control request message CCR to the online charging system OCS (step 1) indicating the requested service units (RSU).

In response, the online charging system OCS sends an initial credit control answer message CCA back to the gateway GPRS support node GGSN with which it may initiate redirection for those rating groups, where service authorization requires an additional dialogue with the top-up server TS (step 2). Redirection may be initiated also in any other CCA update message.

When the gateway GPRS support node GGSN detects a HTTP traffic request related to a rating group where redirection is enabled, it will redirect the traffic request to the top-up server TS (step 3).

The top-up server TS provides a service authorization dialogue to the end-user EU (step 4) by e.g. receiving “accept message” etc.

Based on the dialogue result, the top-up server TS responds to the end user EU. The response message (e.g. “inform”) includes an authorization token (Step 5). When the gateway GPRS support node GGSN detects the authorization token in the response message coming from a trusted top-up server TS, it will remove the token from HTTP response before forwarding the response to e.g. the user equipment of the end user EU (step 5). Further, gateway GPRS support node GGSN will initiate service authorization towards the online charging system OCS (Step 6) by sending a credit control request message CCR indicating the requested service units (RSU) to the online charging system OCS and asks quota for a related rating group. The authorization token is also included in the CCR message (step 6).

The online charging system OCS verifies and validates the authorization token. Depending on the result, it either allows or denies access to content services. The authorization result is passed back to the gateway GPRS support node GGSN in a credit control answer message CCA (step 7) which may then indicate the granted service units (GSU). Eventually, the gateway GPRS support node GGSN stops redirecting traffic after the credit control answer message CCA has been received (step 8).

Accordingly, in view of the alternative approach of sending authorization token from the UE as discussed above, the following advantages are achieved.

No buffering of e.g. the user traffic requests is required. Redirection is initiated before there is traffic which needs to be redirected. If redirection is not removed before some user equipment tries to access the content service, traffic requests are redirected to the top-up server which can inform the end-user that subscription activation is still in progress.

The top-up server can also delay step 8 so that there is enough time for CCR-CCA interaction before step 8, and thus, when the user equipment is trying to access the service, redirection has already been removed from the gateway GPRS support node. This delaying can be done using known hypertext markup language (HTML) or wireless markup language (WML) tags.

In short, the top-up server may actually delay redirection of traffic back to original site. By doing so, there is some time to handle the signalling between the gateway GPRS support node and the online charging system.

Moreover, the solution according to embodiments also works for non-HTTP services. The dialogue is always provided with HTTP so that the authorization token can be sent from the top-up server, but the actual usage of services can be based on any protocol.

Furthermore, the solution according to embodiments is secure. The authorization token is accepted only from a trusted server (like for example a top-up server), i.e. such nodes can be configured in the gateway GPRS support node.

For example the gateway GPRS support will ignore an authorization token if it is coming from the user equipment, because user equipment is not configured as trusted source for the authorization token.

With respect to the disadvantage of a alternative solution that it is designed for single sign-on functionality, and that it cannot be used to make service re-authorization decisions based on usage of content resources, the solution according to embodiments gives the possibility of making usage-based decisions practically “free”. In detail, embodiments are based on using online charging interface for controlling redirection and authentication. In other words, usage control and reporting are inherent parts of online charging interface. In contrast thereto, Liberty interfaces are used only for passing authentication and authorization signals, and there is no usage control or reporting. CCR and CCA messages exchanged between the gateway GPRS support node and the online charging system are used also reporting usage data and grant quota for service usage.

It should be noted that the token mechanism described in steps 5 and 6 can be used also to implement other goals than advice of charge and subscriptions. If the top-up server is actually the server providing the content, the token can be used to trigger chargeable events from the top-up server. These chargeable events can then be used to generate charging actions in the online charging system based on e.g. the downloading or uploading of content, revenue sharing, getting some promotional ticket which grants temporarily free access to services, or any other charging policy decision based on the input received from content provider.

Finally, with respect to the above mentioned “token”, the following is to be noted. The triad OCS/GGSN/TS is in the state “handling top-up and inhibiting chargeable traffic” and “pass chargeable traffic”. A state change must be communicated to the GGSN, wherein it can either come from the top-up server or the online charging system. This would be the “token”.

Moreover, according to embodiments, this token is used in a specific way. Embodiments provide a way that is least complex for both the online charging system and the gateway GPRS support node.

Specifically, an interface between online charging system and a top-up server may be considered to be more complex because of the following. Firstly, such an interface would currently be non-standardized and would be a vendor proprietary interface. Hence, the solution according to embodiments circumvents this problem. Secondly, as addressed above, the gateway GPRS support node must be informed of the state change. The top-up server or the online charging system can do that.

However, all solutions requiring the online charging system to do this directly have the disadvantage of creating “triangle” communications (i.e. GGSN->TS->OCS->GGSN . . . vs. GGSN->TS->OCS->TS->GGSN->OCS->GGSN). These disadvantages are severe. The reason is that the triangle approach is more costly (mainly due to higher complexity), timeout problems concern the three-way communication, and correlation-identities must be transported and agreed upon by three partners, wherein the interface TS<->OCS is non-standardized, to name just a few.

An implementation of embodiments may be achieved by providing a computer program product embodied as a computer readable medium which stores instructions according to the above described embodiments.

Thus, the above description includes a method of providing service authorization. The method includes sending a message from a redirect server to a user terminal including an authorization token. Further, the method includes detecting and removing the authorization token by a network gateway node from the message before forwarding the message to the user terminal.

What has been described above is what is presently considered to be embodiments and examples. However, as is apparent to the skilled reader, these are provided for illustrative purposes only and that all variations and modifications are to be included which fall within the spirit and scope of the appended claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-24. (canceled)

25. A method of providing service authorization, comprising:
sending a message, including an authorization token, from a redirect server to a user terminal; and
detecting and removing the authorization token from the message by a network gateway node before forwarding the message to the user terminal.

26. The method according to claim 25,
further comprising performing an authorization dialogue with the user terminal by the redirect server, and
wherein the message sent from the redirect server to the user terminal is a response message within the authorization dialogue.

27. The method according to claim 25, further comprising initiating a service authorization request by the network gateway node towards an online charging system after the forwarding of the message and before the user terminal requests any traffic after receiving the message.

28. The method according to claim 27, further comprising delaying by the redirect server, sending of any traffic by the terminal.

29. The method according to claim 27, further comprising performing the service authorization request by sending a credit control request message to the online charging system which includes the authorization token and asks for permission of a requested service.

30. The method according to claim 25, further comprising initiating redirection of traffic from a user terminal to a redirect server by informing the network gateway node in advance before traffic is sent by the user terminal.

31. The method according to claim 30, wherein said initiating is performed in response to creation of a packet data protocol context for the user terminal.

32. The method according to claim 30, further comprising informing the network gateway node in advance by the online charging system.

33. The method according to claim 25, wherein the network gateway node is a gateway general packet radio service support node.

34. The method according to claim 25, wherein the redirect server is a top-up server.

35. A non-transitory computer-readable medium encoded with a computer program that when executed by a processor causes the processor to carry out a method comprising:
sending a message, including an authorization token, from a redirect server to a user terminal; and
detecting and removing the authorization token from the message by a network gateway node before forwarding the message to the user terminal.

36. The non-transitory computer-readable medium according to claim 35,
wherein said method further comprises performing an authorization dialogue with the user terminal by the redirect server, and
wherein the message sent from the redirect server to the user terminal is a response message within the authorization dialogue.

37. The non-transitory computer-readable medium according to claim 35, wherein said method further comprises initiating a service authorization request by the network gateway node towards an online charging system after the forwarding of the message and before the user terminal requests any traffic after receiving the message.

38. The non-transitory computer-readable medium according to claim 37, wherein said method further comprises performing the service authorization request by sending a credit control request message to the online charging system which includes the authorization token and asks for permission of a requested service.

39. The non-transitory computer-readable medium according to claim 35, wherein said method further comprises initiating redirection of traffic from a user terminal to a redirect server by informing the network gateway node in advance before traffic is sent by the user terminal.

40. A network gateway device communicating with a redirect server and a user terminal via a network, comprising:
a processor programmed to detect and remove an authorization token from a message from the redirect server to the user terminal; and
an interface, coupled to the network, forwarding the message to the user terminal after removal of the authorization token.

41. The network gateway device according to claim 40, wherein the network gateway device is coupled to an online charging system, and
wherein said interface sends a service authorization request towards the online charging system after the forwarding of the message and before the user terminal requests any traffic after receiving the message.

42. The network gateway device according to claim 41, wherein said interface sends the service authorization request to the online charging system with a credit control request message that includes the authorization token and asks for permission of a requested service.

43. The network gateway device according to claim 40, wherein said processor is programmed to redirect traffic from the user terminal to the redirect server, before traffic is requested by the user terminal, in response to information received to initiate redirection of the traffic.

44. The network gateway device according to claim 40, wherein the network gateway device is a gateway general packet radio service support node.
